(19) United States
(12) Patent Application Publication
(10) Pub. No.: US 2012/0156542 A1
(43) Pub. Date: Jun. 21, 2012

(54) BATTERY CELL HAVING A JACKET

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/145,727

(22) PCT Filed: Jan. 19, 2010
(86) PCT No.: PCT/EP10/00287

§ 371 Date: Mar. 6, 2012

(30) Foreign Application Priority Data
Jan. 23, 2009 (DE) 10 2009 005 854.0

(51) Int. Cl. H01M 10/50

(52) U.S. Cl. 429/120

(57) ABSTRACT

The invention relates to a battery cell (1) particularly of a prismatic or cylindrical design, comprising at least two electrode stacks (2), at least one current conductor connected to an electrode stack (2), a jacket (4) that at least partially encloses the electrode stack (2), at least one current conductor (3) extending partially out of the jacket (4), characterized in that a heat conducting plate (5) is arranged between two electrode stacks (2).

The present invention relates to a battery cell. Such battery cells comprise at least one electrical cell which is provided for the storage of electrical energy. Use is made both of primary batteries and secondary batteries, i.e. non-rechargeable and rechargeable batteries. Such battery cells are often a component of battery arrangements that comprise a plurality of such battery cells. They are often used in electrically driven vehicles. The present battery cell relates in particular to a binary cell. As a rule, binary cells have at least two electrical cells under a common jacket, wherein both electrical cells act independently of one another, but can be connected to one another.

A battery in a bipolar stack design is known from DE 199 29 950 A1. The battery comprises a plurality of sub-cells each with two electrodes of differing polarity, said sub-cells being housed in a container sealed gas-tight. An electrically conductive connecting wall is disposed between electrodes of unlike polarity of adjacent sub-cells.

The problem underlying the invention is to provide an improved battery cell of the aforementioned kind.

The problem underlying the invention is solved by a battery cell with an, in particular, prismatic or cylindrical shape comprising at least two electrode stacks, at least one current conductor which is connected to an electrode stack, a jacket which at least partially encloses the electrode stack, wherein at least one current conductor partially extends out of the jacket, wherein a heat conducting plate is disposed between two electrode stacks.

An electrode stack is understood to mean an arrangement with at least two electrodes and an electrolyte arranged between two such electrodes. An electrode stack is used for the storage of chemical energy and for its conversion into electrical energy. Conversely, the electrode stack can also be used to convert electrical energy into chemical energy if it concerns a rechargeable battery.

A current conductor is an element which is produced from an electrically conductive material. It is used to conduct current between two points geometrically separated from one another. In the present case, a current conductor is connected to an electrode stack. In particular, the current conductor is connected to all the electrodes of an electrode stack that are of the same kind, i.e. either to the cathodes or to the anodes. It is obvious that a current conductor is not connected at the same time to the cathodes and anodes of an electrode stack, since this would lead to a short circuit. However, a current conductor can be connected to different electrodes of different electrode stacks, i.e. in the case of a series connection of both electrode stacks for example. At least one current conductor extends out of the jacket and can be used to connect the battery cells to the exterior. The current conductor can be constituted in one piece with one or more electrodes.

Within the scope of the invention, jacket is understood to mean an at least partial boundary which delimits the electrode stack with respect to the exterior. The jacket is preferably gas-tight and liquid-tight, so that a substance exchange with the surroundings cannot occur. The electrode stacks are disposed inside the jacket. At least one current conductor, in particular two current conductors, extends out of the jacket and is used for the connection of the electrode stacks. The current conductors extending outwards preferably represent the positive pole connection and the negative pole connection of the battery cell. However, a plurality of current conductors can also extend out of the jacket, in particular four current conductors. If the battery cell comprises two electrode stacks which are connected to one another in series, two electrodes of different electrode stacks are connected to one another.

The jacket can be constituted by a fixed housing. The housing can however also be made from a material which is not dimensionally stable, such as for example a film. Particularly when the jacket is formed from a film, the heat conducting plate acts as a stabilising element, which endows the battery cell with a stable shape. Despite a non-dimensionally stable jacket, the battery cell therefore has a stable shape and can be used without further support elements.

The heat conducting plate disposed between two electrode stacks is used on the one hand as a partition between two electrode stacks. The heat conducting plate is preferably constituted such that it seals cell spaces, in each of which one electrode stack is located, from one another in a gas-tight and liquid-tight manner. Furthermore, the heat conducting plate has the function of conducting away the heat arising, which in particular arises from during the conversion of electrical energy into chemical energy and vice versa. A section of the heat conducting plate also preferably extends out of the jacket, so that, by means of the heat conducting plate, heat can be conducted from inside the jacket to outside the jacket. For this purpose, the heat conducting plate preferably has a good thermal conductivity and in particular a higher thermal conductivity than the jacket.

The heat conducting plate is preferably produced from a fibre composite or a combination of fibre composites. Such fibre composites usually have a lower specific weight than, for example, conventional materials that can be used for this purpose, such as sheet metal for example. In particular, heat-conducting fibres can be used, which can increase the thermal conductivity of the fibre composite or the combination of fibre composites. Furthermore, the fibre composite or the combination of fibre composites can be constituted such that the heat conducting plate has a high mechanical stability. Overall, the embodiment of the heat conducting plate comprising a fibre composite or a combination of fibre composites can produce a heat conducting plate which offers good heat-conducting properties at the same time as high mechanical stability and low weight.

In order to produce a connection between the two electrode stacks, an electrical connection between two electrodes of the electrode stacks is required. Since the heat conducting plate preferably forms a leak-proof partition between the electrode stacks, the heat conducting plate preferably comprises an opening for this purpose. Preferably disposed in the opening is a contact element which, in particular, forms an electrically conductive connection between the outer surfaces of the heat conducting plate. A current conductor can form the contact element. An electrical conduction is thus produced which penetrates the heat conducting plate. In order to ensure, however, that the heat conducting plate can form a gas-tight and liquid-tight partition between the electrode stacks, an insulator can be disposed in an annular space between the contact element and the heating plate. This insulator, together with the contact element, can seal the opening, so that the sealing effect of the heat conducting plate is restored. The insulator is preferably constituted annular. The insulator can comprise a peripheral groove, into which a wall of the heat conducting plate can engage. The sealing effect is thus improved and a secure support for the insulator is favoured.

A first electrode stack is preferably connected to a first side of the contact element and a second electrode stack to a second side of the contact element. The two sides are disposed in particular at different external surfaces of the heat conducting plate. By connecting the electrode stacks to the contact element, the two electrode stacks are connected to one another, in particular connected in series. Electrodes of the electrode stacks can be connected to the contact element, respectively.

One or more electrodes can be connected directly to the contact element. Alternatively, the connection between electrode and contact element can also take place indirectly, for example via a current conductor.

Viewed in cross-section, the contact element preferably has a width that is greater than the cross-sectional thickness of the heat conducting plate. The contact between the electrode stack and the contact element is thus facilitated, since the contact element thereby projects somewhat from the heat conducting plate. In particular, the contact element projects from the heat conducting plate on both sides of the heat conducting plate. Viewed in cross-section, the insulator also preferably has a width that is greater than a cross-sectional thickness of the heat conducting plate. The sealing effect and insulating effect of the insulator is thus improved. Furthermore, the insulator, as a result of a greater width, is also robust against falling out of the opening. In cross-section, the contact element preferably has a width that is greater than a width of the insulator. This also facilitates making contact, since the contact element projects somewhat out of the insulator.

The jacket is preferably produced from a film. The jacket can also preferably be produced from a composite, in particular a composite film. The jacket can in particular be dimensionally unstable, which gives rise to savings on weight and cost. In this case, the stability of the battery cell can be produced chiefly by the heat conducting plate, which can have a greater dimensional rigidity.

Alternatively, the jacket can comprise at least one formed part, which can be constituted dimensionally stable, in particular by deep drawing. The formed part is to be understood as a solid body, which in particular is adapted to the shape of the electrode stack.

The formed part does not necessarily have to exhibit dimensional stability, but can acquire its dimensional stability only with another formed part or in the interaction with the heat conducting plate. In particular, the two formed parts, which can be constituted substantially identical, form the jacket. The formed part is in particular heat-conducting, but electrically insulating. In particular, it seals a cell space, in which the electrode stack is accommodated, in a gas-tight and liquid-tight manner with respect to the exterior.

The heat conducting plate preferably penetrates the jacket and, in particular, comprises a heat transfer region which is disposed outside the jacket. The heat transfer region is used to carry away the heat from the battery cell. Since the heat conducting plate has in particular a high thermal conductivity, sufficient cooling of the battery cell can thus be promoted.

Devices for connecting the heat conducting plate to a support element can preferably be provided on a section of the heat conducting plate that extends out of the jacket, which can be achieved in particular by holes through which a screw or bolt can be passed. By means of such a screw, the heat conducting plate and therefore the battery cell can be fixed to a support element.

The jacket is preferably connected in a firmly bonded manner to the heat conducting plate. The jacket can be connected to the heat conducting plate by means of an adhesive joint.

In a specific embodiment, the battery cell can comprise two electrode stacks, a current conductor of each of the electrode stacks extending out of the jacket. The current conductor assigned to each of the electrode stacks is connected to at least one electrode of the electrode stack. Precisely two current conductors, i.e. one current conductor per electrode stack, thus project out of the jacket. The number of current conductors extending through the jacket is therefore small, which brings about a reduction in points that are difficult to seal. The other electrodes, which are not connected to a current conductor extending through the jacket, are preferably connected electrically to one another inside the jacket. Apart from the one electrode stack that is connected to the exterior by means of a current conductor, another electrode of the electrode stack is preferably connected to the contact element. An electrode of another electrode stack is also preferably connected to the contact element. In this regard, a connection of the two electrode stacks results, wherein the two electrode stacks can be connected in series. Alternatively, the electrode stacks can also be connected in parallel.

The problem underlying the invention is also solved by a battery arrangement which comprises a plurality of battery cells of the aforementioned kind. A battery cell on its heat conducting plate is preferably held in the battery arrangement, in particular to a housing of the battery arrangement.

The battery cell with its heat conducting plate can be screwed to a housing of the battery arrangement. Alternatively, a section of the heat conducting plate of a battery cell can be accommodated in a guide groove of a housing. A part of the jacket, in particular the seam section, can also be held in the guide groove. Both variants are advantageous especially when the jacket of the battery cell is produced from a dimensionally non-stable material, such as for example a film. The heat conducting plate provides stability for the battery cell and can therefore be used for the fixed connection of the battery cell to a housing of the battery arrangement.

According to the invention, a battery cell of the aforementioned kind can be produced by a method, wherein the method comprises the following process steps:
placing a first electrode stack on a first side of a heat conducting plate,
placing a second electrode stack on a second side of the heat conducting plate,
wrapping of the electrode stack and the heat conducting plate at least partially.

The heat conducting plate serves as a shape-stabilising element, so that the film forming the jacket can itself be dimensionally non-stable.

An electrode of the first electrode stack is preferably connected to an electrode of the second electrode stack before the wrapping with film.

The electrical connection between the electrodes of different electrode stacks can thus be formed inside the jacket formed by the film. An electrical connection is preferably passed through an opening of the heat conducting plate for this purpose. This electrical connection through the opening can be implemented by means of a contact element that is disposed in the opening. Electrodes are connected to the contact element on different sides, respectively.

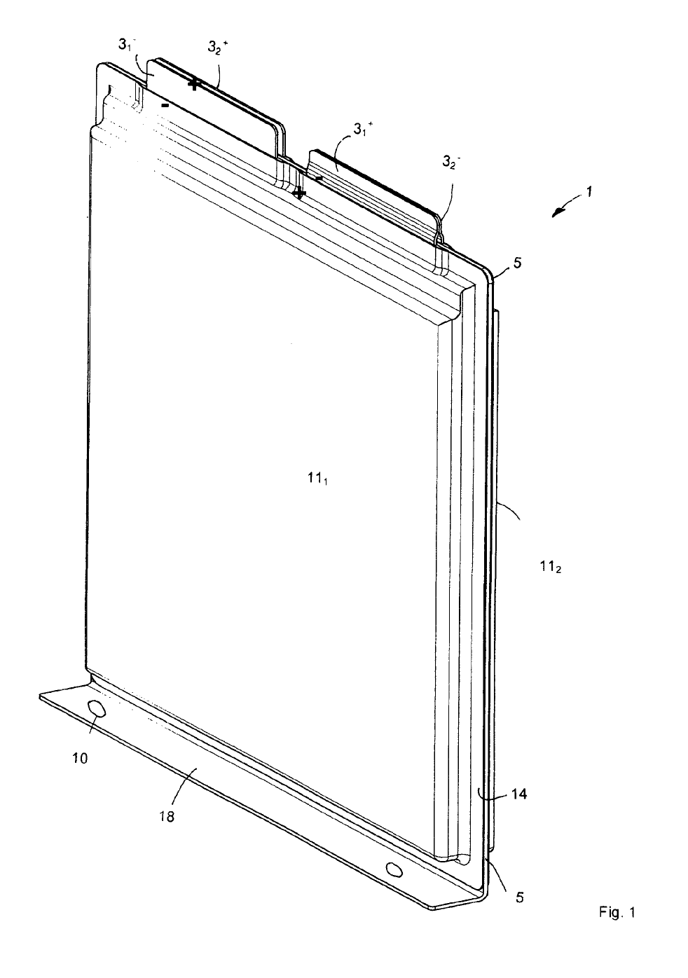

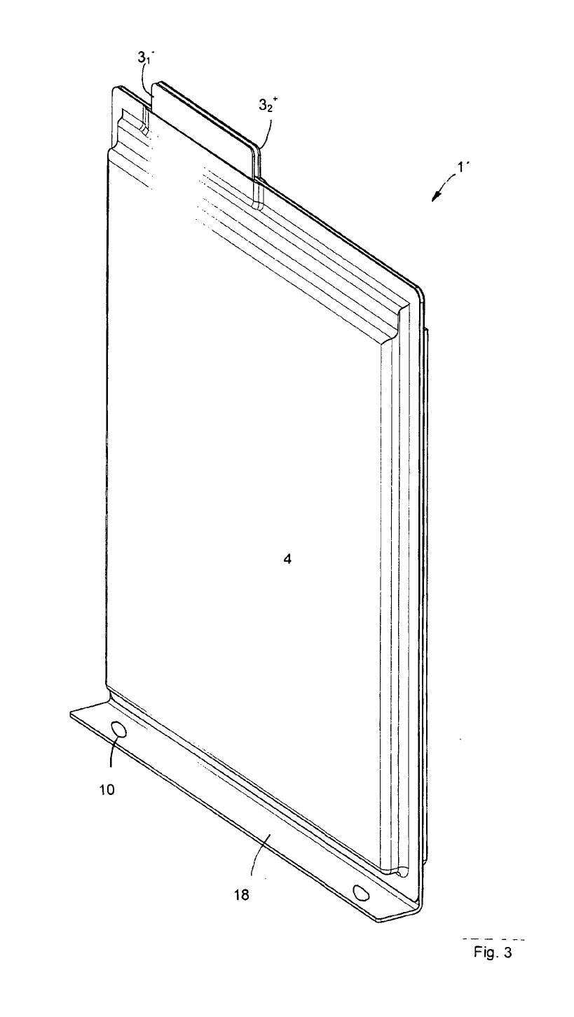

The invention is explained in greater detail below with the aid of the figures, which show:
a battery cell in a perspective view;
a cross-sectional view through the battery cell according to FIG. 1;
a further battery cell according to the invention in a perspective view;
a cross-sectional view through the battery cell according to FIG. 3;
a detail of the battery cell according to FIG. 3 in a perspective view;
the battery cell according to FIG. 3 in an exploded view.

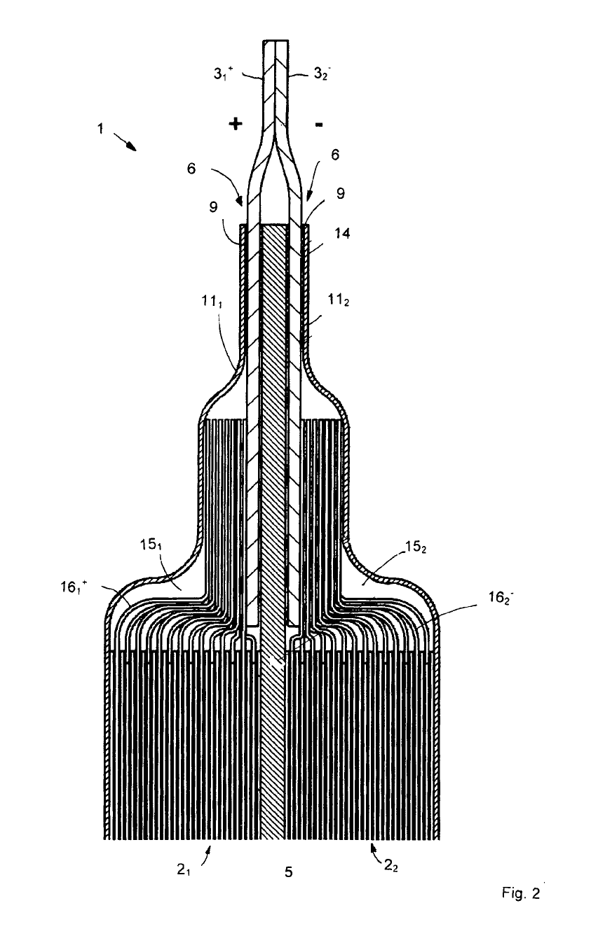

FIGS. 1 and 2 show a battery cell 1 which comprises a jacket 4. Jacket 4 is formed by a first formed part 11₁ and a second formed part 11₂. Formed parts 11₁ and 11₂ each form shell-shaped housing parts. Deep drawn parts 11₁ and 11₂ comprise a peripheral seam section 14. Each of formed parts 11 lies with seam section 14 on a heat conducting plate 5. The seam section is connected in a firmly bonded manner to the heat conducting plate by means of an adhesive joint. The two seam sections 14 of formed parts 11₁, 11₂ do not make contact with one another. Strictly speaking, heat conducting plate 5 in this regard also represents a part of jacket 4, since it seals a gap between seam sections 14.

A cell space 15 is formed between each of formed parts 11 and heat conducting plate 5. A first cell space 15₁ is present between first formed 11₁ and heating plate 5. A second cell space 15₂ is disposed on the side of heat conducting plate 5 facing away from first cell space 15₁ and is formed between heat conducting plate 5 and second formed part 11₂. The two cell spaces 15₁, 15₂ are sealed off with respect to one another, so that no substance exchange is possible between the two cell spaces 15.

A first electrode stack 2₁ is disposed inside first cell space 15₁. A second electrode stack 2₂ is disposed inside second cell space 15₂.

FIG. 2 shows battery cell 1 in a cross-sectional view in the region of current conductors 3₁⁺ and 3₂⁻. A cathode 16₁⁺ of first electrode stack 2₁ can be seen inside first cell space 15₁. Furthermore, anode 16₂⁻ of first electrode stack 2₂ can be seen inside second cell space 15₂.

Electrodes 16 of the same kind, i.e. cathodes or anodes in each case, of individual electrode stacks 2 are connected to one another in a firmly bonded manner by laser welding. Current conductors 3₁⁺ and 3₂⁻ are also connected in a firmly bonded manner to electrodes 16₁⁺ and 16₂⁻ by laser welding. Current conductors 3 are used for an electrical connection to the exterior, outside jacket 4. For this purpose, current conductors 3 extend each through an opening 6 of jacket 4, said opening being formed between first formed part 11₁ and heat conducting plate 5 and respectively second formed part 11₂ and heat conducting plate 5. The possibility of connection from the exterior to electrodes 16 of battery cell 1 is thus created. Current conductors 3₁⁺ and 3₂⁻ are also connected to one another in a firmly bonded manner by means of laser welding.

Apart from one of current conductors 3, a sealing strip 9 is also disposed in each opening 6. Sealing strip 9 winds round current conductor 3 in the region of opening 6 over a width which corresponds to the seating surface of current conductor 3 in opening 6. Current conductor 3 cannot therefore enter into a current-transferring connection with jacket 4 and heat conducting plate 5. For this purpose, sealing strip 9 is approximately as wide as a seam section 14, at which current conductor 3 lies adjacent to jacket 4. Heat conducting plate 5 is further produced from electrically non-conductive fibre composites. Alternatively, the heat conducting plate can also be produced from an electrically conductive material. It then preferably comprises an insulating layer at its surface, so that no current transfer from one of the cell spaces to the heat conducting plate can take place. Not shown in FIGS. 1 and 2 are other electrodes 16₁⁻ and 16₂⁺ of battery cell 1. The latter are connected, like the other electrodes, to respective electrode stacks 2 and are also connected to current conductors 3₁⁻ and 3₂⁺ which, similar to the situation described under FIG. 2, penetrate the jacket and project out of battery cell 1. Unlike in FIG. 2, current conductors 3₁⁻ and 3₂⁺ are not connected to one another in an electrically conductive manner. Current conductors 3₁⁻ and 3₂⁺ represent the connections of the battery cell.

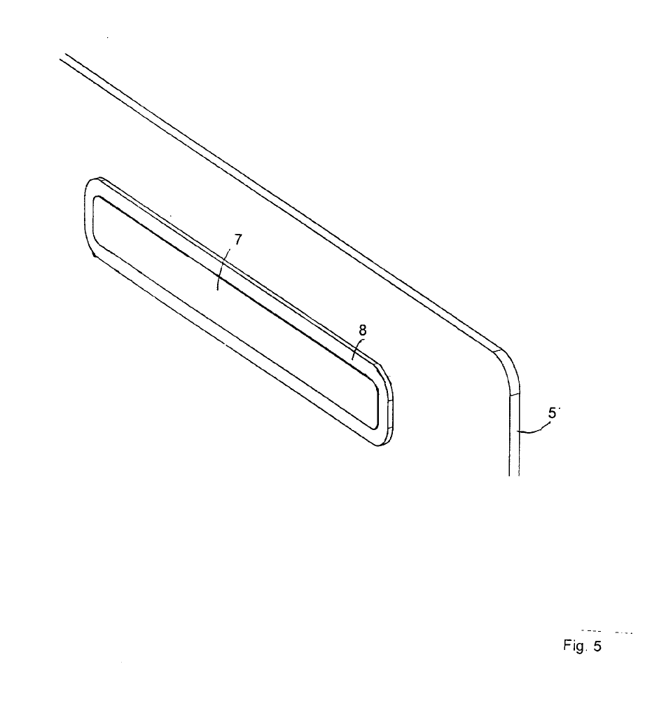

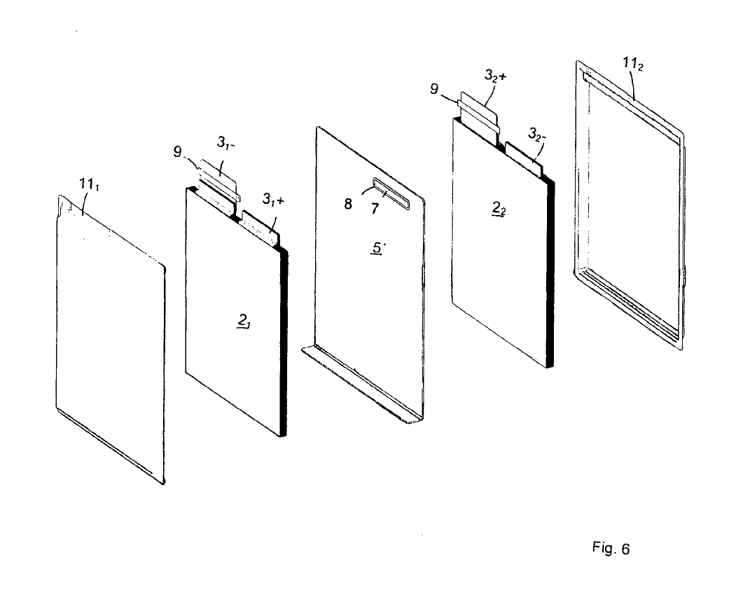

FIGS. 3 to 6 show a battery cell 1′, which is a further development of the battery cell according to FIG. 1. It can be seen that only two current conductors, i.e. current conductors 3₁⁻ and 3₂⁺, extend out of jacket 4. The connection of electrode stacks 2₁ and 2₂, which in battery cell 1 according to FIG. 1 takes place outside jacket 4 by connecting current conductors 3₁⁺ and 3₂⁻, is now achieved in a different way, as follows.

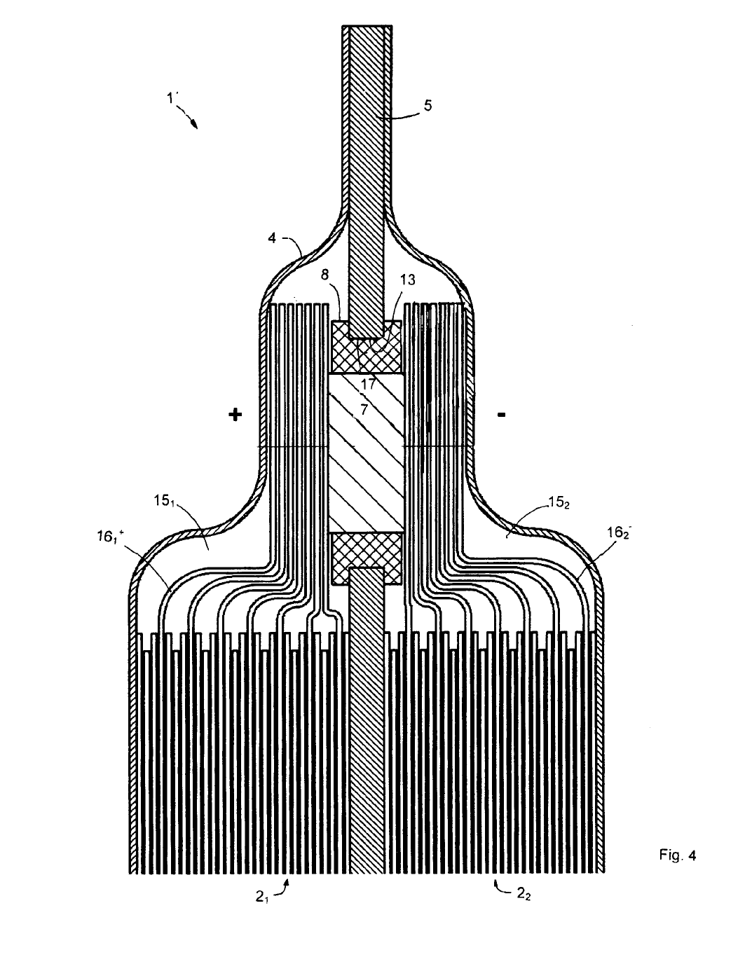

FIG. 4 shows a cross-sectional view through battery cell 1′, wherein the cross-section has been taken at the same point as in FIG. 2. It can be seen that heat conducting plate 5′ comprises an opening 13.

Disposed in opening 13 is a contact element 7, which enables an electrical connection between the two cell spaces 15₁ and 15₂. Cathodes 16₁⁺ of first electrode stack 2₁ are connected to a first side of contact element 7. Anodes 16₂⁻ of second electrode stack 2₂ are disposed at a second side of contact element 7. Disposed in an annular space 12, which is formed between contact element 7 and opening 13, is an insulator 8, which sits in a sealing manner between heat conducting plate 5 and contact element 7. Cell spaces 15₁ and 15₂ are sealed off from one another by insulator 8, so that no substance exchange between the two cell spaces is possible.

Insulator 8 comprises a peripheral groove 17, into which heat conducting plate 5 projects. The sealing effect of insulator 8 with respect to heat conducting plate 5 is thus improved.

Both battery cell 1 according to FIG. 1 and battery cell 1′ according to FIG. 3 comprise a heat transfer region 18. Heat transfer region 18 is connected in one piece to heat conducting plate 5, which projects out of jacket 4, and comprises two holes 10, with which the heat conducting plate can be rigidly connected to a housing of a battery arrangement.

As an alternative to the embodiment of the jacket by means of the two formed parts 11, the jacket can be formed by a film. During assembly of battery cell 1, electrode stacks 2 are first seated on heat conducting plate 5. Electrodes 16 of electrode stacks 2 are then connected from different sides to contact element 7. The film is then at least partially wrapped round electrode stacks 2 and heat conducting plate 5. Sections of heat conducting plate 5 and individual current conductors 3 can continue to extend out of jacket 4 which is formed by the film.

### LIST OF REFERENCE NUMBERS

1 battery cell
2 electrode stack
3 current conductor
4 jacket
5 heat conducting plate
6 opening
7 contact element
8 insulator
9 sealing strip
10 hole
11 deep drawn part
12 annular space
13 opening
14 seam section
15 cell space
16 electrode
17 groove
18 heat transfer region
B₁ width of contact element
B₂ cross-section of heat conducting plate
B₃ width of insulator

1. A battery cell (1) with an, in particular, prismatic or cylindrical shape, comprising:
at least two electrode stacks (2),
at least one current conductor (3) which is connected to an electrode stack (2),
a jacket (4) which at least partially encloses the electrode stacks (2), wherein at least one current conductor (3) partially extends out of the jacket (4),
wherein
a heat conducting plate (5) is disposed between two electrode stacks (2).

2. The battery cell (1) according to claim 1,
wherein
the heat conducting plate (5) is produced from a fibre composite or from a combination of fibre composites and the heat conducting plate (5) comprises an opening (3).

3. (canceled)

4. The battery cell (1) according to claim 2,
wherein
a contact element (7) is disposed in the opening (13) and an insulator (8) is disposed in an annular space (12) between the contact element (7) and the heat conducting plate (5).

5. (canceled)

6. The battery cell (1) according to claim 4,
wherein
a first electrode stack (2) is connected to a first side of the contact element (7) and a second electrode stack (2) is connected to a second side of the contact element (7).

7. The battery cell (1) according to claim 6,
wherein
viewed in cross-section, the contact element (7) has a width (B1) which is greater than the cross-sectional thickness (B2) of the heat conducting plate (5).

8. The battery cell (1) according to claim 7,
wherein
viewed in cross-section, the insulator (8) has a width (B3) which is greater than a cross-sectional thickness (B2) of the heat conducting plate (5).

9. The battery cell (1) according to claim 8,
wherein
in cross-section, the contact element (7) has a width (B1) which is greater than a width (B3) of the insulator (8) and the jacket (4) is produced from a film.

10. (canceled)

11. The battery cell (1) according to claim 9,
wherein
the jacket (4) is produced from a composite, in particular a composite film and the jacket (4) comprises at least one formed part (11).

12. (canceled)

13. The battery cell (1) according to claim 11,
wherein
the formed part (11) is constituted dimensionally stable by means of deep drawing.

14. The battery cell (1) according to claim 13,
wherein
the heat conducting plate (5) penetrates the jacket (4).

15. The battery cell (1) according to claim 14,
wherein
the heat conducting plate (5) comprises a heat transfer region (18) which is disposed outside the jacket (4) and the jacket (4) is connected in a firmly bonded manner to the heat conducting plate (5).

16. (canceled)

17. The battery cell (1) according to claim 15,
wherein
the jacket (4) comprises an opening (6) through which a current conductor (3) is passed, wherein a sealing strip (9) is disposed between the current conductor (3) and the jacket (4).

18. The battery cell (1) according to claim 17,
wherein
two electrode stacks (2) are provided, wherein a current conductor (3) of each of the electrode stacks (2) extends out of the jacket (4).

19. The battery cell (1) according to claim 18,
wherein
a further current conductor (3) of an electrode stack (2) is connected to the contact element (7).

20. The battery cell (1) according to claim 19,
wherein
two electrode stacks (2) are connected in series.

21. The battery cell (1) according to claim 20,
wherein
two electrode stacks (2) are connected in parallel.

22. The battery cell (1) according to claim 21,
wherein
electrode stacks (2) are connected to one another electrically inside the jacket (4).

23. The battery cell (1) according to claim 22,
wherein
at least one current conductor (3) is connected in a firmly bonded manner to the contact element (7), in particular by means of laser welding or ultrasonic welding.

24. The battery cell (1) according to claim 23,
wherein
electrodes (16) are connected in an electrically conductive manner to a current conductor (3).

25. (canceled)

26. A battery arrangement comprising a plurality of battery cells (1) according to claim 1,
wherein
a battery cell (1) is held in the battery arrangement by its heat conducting plate (5) and the battery cell (1) is screwed to a housing of the battery arrangement by its heat conducting plate (5).

27. (canceled)

28. The battery cell (1) according to claim 26,
wherein
a section of the heat conducting plate (5) of at least one battery cell (1) is received in a guide groove of a housing.

29.-30. (canceled)
